(19) United States
(12) Patent Application Publication
(10) Pub. No.: US 2025/0255353 A1
(43) Pub. Date: Aug. 14, 2025

(54) AEROSOL DELIVERY SYSTEM

(71) Applicant: NICOVENTURES TRADING LIMITED, London (GB)

(72) Inventor: Patrick MOLONEY, Malmesbury (GB)

(21) Appl. No.: 18/867,206

(22) PCT Filed: May 18, 2023
(86) PCT No.: PCT/GB2023/051315

§ 371 Date: Nov. 19, 2024

(30) Foreign Application Priority Data
May 20, 2022 (GB) 2207413.2

(51) Int. Cl. A24F 40/57; A24F 40/51; A24F 40/53; H05B 6/10

(52) U.S. Cl. CPC A24F 40/57; A24F 40/51; A24F 40/53; H05B 6/108

(57) ABSTRACT

A non-combustible aerosol delivery device including a controller and a power source, the controller configured to deliver power to an aerosol generator according to one or more power profiles selected from at least a sensing power profile and an aerosolization power profile, wherein the sensing power is insufficient to increase the temperature of the aerosol generator above about 100° C.

### RELATED APPLICATIONS

The present application is a National Phase entry of PCT Application No. PCT/GB2023/051315 filed May 18, 2023, which claims priority to GB Application No. 2207413.2 filed May 20, 2022, each of which is hereby incorporated by reference in their entirety.

### FIELD

The present invention relates to an aerosol delivery system. The system may comprise an aerosol delivery device and an aerosolizable material. The present invention also relates to the aerosol delivery device of the aerosol delivery system and to methods of operating an aerosol delivery system.

### BACKGROUND

Aerosol delivery systems which generate an aerosol for inhalation by a user are known in the art. Such systems typically comprise an aerosol generator which is capable of converting an aerosolizable material into an aerosol. In some instances, the aerosol generated is a condensation aerosol whereby an aerosolizable material is heated to form a vapor which is then allowed to condense into an aerosol. In these instances, the aerosolizable material may be heated to a temperature such that the aerosolizable material undergoes combustion. In this case, the system may be referred to as a combustible aerosol delivery system. In other instances, the aerosolizable material may be heated to a temperature such that the aerosolizable material does not undergo combustion, even though it is heated. In this case, the system may be referred to as a non-combustible aerosol delivery system. In some non-combustible aerosol delivery systems, it is not necessary to heat the aerosolizable material in order to form the aerosol. For example, the aerosol generated may be an aerosol which results from the atomization of the aerosolizable material. Such atomization may be brought about mechanically, e.g. by subjecting the aerosolizable material to vibrations so as to form small particles of material that are entrained in airflow. Alternatively, such atomization may be brought about electrostatically, or in other ways, such as by using pressure etc.

Since such aerosol delivery systems are intended to generate an aerosol which is to be inhaled by a user, it may be desirable for the device to operate in a manner which is consistent with such patterns. Indeed, in some cases it is known that the system can be activated as a result of a sensed inhalation. It would be desirable to provide further systems the operation of which is linked to inhalation patterns.

### SUMMARY

In one aspect there is provided a non-combustible aerosol delivery device comprising a controller and a power source, the controller configured to deliver power to an aerosol generator according to one or more power profiles selected from at least a sensing power profile and an aerosolization power profile, wherein a power according to the sensing power profile is insufficient to increase the temperature of the aerosol generator above about 100° C.

In a further aspect there is provided a method of sensing the commencement of airflow through an aerosol delivery device, the method comprising the steps of:
providing an aerosol delivery device comprising a controller and a power source, wherein the controller is configured to deliver power according to an aerosol generator according to one or more power profiles selected from at least a sensing power profile and an aerosolization power profile, wherein the sensing power profile is insufficient to increase the temperature of the aerosol generator above about 100° C.,
delivering power to an aerosol generator according to the sensing power profile;
determining whilst delivering power according to the sensing power profile a change in a relationship between the power delivered to the aerosol generator and temperature of the aerosol generator.

These aspects and other aspects of the present invention will be apparent from the following detailed description. In this regard, particular sections of the description are not to be read in isolation from other sections.

### BRIEF DESCRIPTION OF THE DRAWINGS

Various embodiments will now be described in detail by way of example only with reference to the following drawings:

FIG. 1 shows a cross-section through an example e-cigarette comprising a cartomizer and a controller;

FIG. 2 shows an external perspective exploded view of an example cartomizer in which aspects of the disclosure can be implemented;

FIG. 3 shows a partially cut-away perspective view of the cartomizer of FIG. 2 in an assembled arrangement;

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

As described above, the present disclosure relates to (but is not limited to) non-combustible aerosol provision devices and systems that release compounds from an aerosol-generating material without combusting the aerosol-generating material, such as electronic cigarettes, tobacco heating products, and hybrid systems which generate aerosol using a combination of aerosol-generating materials. In some embodiments, the non-combustible aerosol provision system is an electronic cigarette, also known as a vaping device or electronic nicotine delivery system (END), although it is noted that the presence of nicotine in the aerosol-generating material is not a requirement. In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Throughout the following description the terms “e-cigarette” and “electronic cigarette” may sometimes be used; however, it will be appreciated these terms may be used interchangeably with non-combustible aerosol (vapor) provision system or device.

In some embodiments, the disclosure relates to consumables comprising aerosol-generating material and configured to be used with non-combustible aerosol provision devices. These consumables are sometimes referred to as articles throughout the disclosure.

The non-combustible aerosol provision system, such as a non-combustible aerosol provision device thereof, comprises a power source and a controller. The power source is typically an electric power source.

In some embodiments, the non-combustible aerosol provision system or device may comprise an area for receiving the consumable, an aerosol generator, an aerosol generation area, a housing, a mouthpiece, a filter and/or an aerosol-modifying agent.

In some embodiments, the consumable/article for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

The systems described herein are intended to generate an inhalable aerosol by vaporization of an aerosol generating material. The aerosol generating material may comprise one or more active constituents, one or more flavors, one or more aerosol-former materials, and/or one or more other functional materials.

Aerosol-generating material may, for example, be in the form of a solid, liquid or gel which may or may not contain an active substance and/or flavorants. In some embodiments, the aerosol-generating material may comprise an “amorphous solid”, which may alternatively be referred to in as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

The aerosol-former material may comprise one or more constituents capable of forming an aerosol. In some embodiments, the aerosol-former material may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, coloring agents, preservatives, binders, fillers, stabilizers, and/or antioxidants.

The term “aerosol” may be used interchangeably with “vapor”.

As used herein, the term “component” is used to refer to a part, section, unit, module, assembly or similar of an electronic cigarette or similar device that incorporates several smaller parts or elements, possibly within an exterior housing or wall. An electronic cigarette may be formed or built from one or more such components, and the components may be removably or separably connectable to one another, or may be permanently joined together during manufacture to define the whole electronic cigarette. The present disclosure is applicable to (but not limited to) systems comprising two components separably connectable to one another and configured, for example, as a consumable/article component capable of holding an aerosol generating material (also referred to herein as a cartridge, cartomizer or consumable), and a control unit having a battery for providing electrical power to operate an element for generating vapor from the aerosol generating material.

The present disclosure is particularly concerned with vapor provision systems and components thereof that utilize aerosol generating material in the form of a liquid or a gel which is held in a reservoir, tank, container or other receptacle comprised in the system. An arrangement for delivering the aerosol generating material from the reservoir for the purpose of providing it for vapor/aerosol generation is included. The terms “liquid”, “gel”, “fluid”, “source liquid”, “source gel”, “source fluid” and the like may be used interchangeably with “aerosol generating material” and “aerosol generating material” to refer to aerosolizable substrate material that has a form capable of being stored and delivered in accordance with examples of the present disclosure.

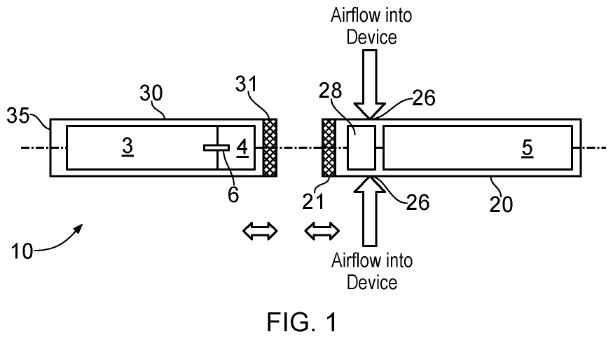

FIG. 1 is a highly schematic diagram (not to scale) of a generic example aerosol/provision system such as an e-cigarette 10, presented for the purpose of showing the relationship between the various parts of a typical system and explaining the general principles of operation. The e-cigarette 10 has a generally elongate shape in this example, extending along a longitudinal axis indicated by a dashed line, and comprises two main components, namely a control or power component, section or unit 20, and a cartridge assembly or section 30 (sometimes referred to as a cartomizer or clearomizer) carrying aerosol generating material and operating as a vapor-generating component.

The cartomizer 30 includes a reservoir 3 containing a source liquid or other aerosolizable substrate material comprising a formulation such as liquid or gel from which an aerosol is to be generated, for example containing nicotine. As an example, the source liquid may comprise around 1 to 3% nicotine and 50% glycerol, with the remainder comprising propylene glycol, and possibly also comprising other components, such as flavorings. Nicotine-free source liquid may also be used, such as to deliver flavoring. A solid substrate (not illustrated), such as a portion of tobacco or other flavor element through which vapor generated from the liquid is passed, may also be included. The reservoir 3 has the form of a storage tank, being a container or receptacle in which source liquid can be stored such that the liquid is free to move and flow within the confines of the tank. For a consumable cartomizer, the reservoir 3 may be sealed after filling during manufacture so as to be disposable after the source liquid is consumed, otherwise, it may have an inlet port or other opening through which new source liquid can be added by the user. The cartomizer 30 also comprises an electrically powered heating element or heater 4 located externally of the reservoir tank 3 for generating the aerosol by vaporization of the source liquid by heating. A liquid transfer or delivery arrangement (liquid transport element) such as a wick or other porous element 6 may be provided to deliver source liquid from the reservoir 3 to the heater 4. A wick 6 may have one or more parts located inside the reservoir 3, or otherwise be in fluid communication with the liquid in the reservoir 3, so as to be able to absorb source liquid and transfer it by wicking or capillary action to other parts of the wick 6 that are adjacent or in contact with the heater 4. This liquid is thereby heated and vaporized, to be replaced by new source liquid from the reservoir for transfer to the heater 4 by the wick 6. The wick may be thought of as a bridge, path or conduit between the reservoir 3 and the heater 4 that delivers or transfers liquid from the reservoir to the heater. Terms including conduit, liquid conduit, liquid transfer path, liquid delivery path, liquid transfer mechanism or element, and liquid delivery mechanism or element may all be used interchangeably herein to refer to a wick or corresponding component or structure.

A heater is an example of an aerosol generating component. The heater may be combined with a wick (or similar). The reservoir with its source liquid plus the aerosol generating component (and optionally wick) may be collectively referred to as an aerosol source. Other terminology may include a liquid delivery assembly or a liquid transfer assembly, where in the present context these terms may be used interchangeably to refer to a vapor-generating element (vapor generator) plus a wicking or similar component or structure (liquid transport element) that delivers or transfers liquid obtained from a reservoir to the vapor generator for vapor/aerosol generation. Various designs are possible, in which the parts may be differently arranged compared with the highly schematic representation of FIG. 1. For example, the wick 6 may be an entirely separate element from the heater 4, or the heater 4 may be configured to be porous and able to perform at least part of the wicking function directly (a metallic mesh, for example).

In an electrical or electronic device, the vapor generating element may be an electrical heating element that operates by ohmic/resistive (Joule) heating or by inductive heating. In general, therefore, an aerosol generator can be considered as one or more elements that implement the functionality of a vapor-generating or vaporizing element able to generate vapor from source liquid delivered to it, and a liquid transport or delivery element able to deliver or transport liquid from a reservoir or similar liquid store to the vapor generator by a wicking action/capillary force. The aerosol generator is typically housed in a cartomizer component of a vapor generating system. In some designs, liquid may be dispensed from a reservoir directly onto a vapor generator with no need for a distinct wicking or capillary element. Embodiments of the disclosure are applicable to all and any such configurations which are consistent with the examples and description herein.

Returning to FIG. 1, the cartomizer 30 also includes a mouthpiece or mouthpiece portion 35 having an opening or air outlet through which a user may inhale the aerosol generated by the aerosol generator 4 (for example a heater).

The device component or power component or control unit 20 includes a cell or battery 5 (referred to herein after as a battery, and which may be re-chargeable) to provide power for electrical components of the e-cigarette 10, in particular to operate the heater 4. Additionally, there is a controller 28 such as a printed circuit board and/or other electronics or circuitry for generally controlling the e-cigarette and directing power to the aerosol generator.

The control electronics/circuitry 28 operates the heater 4 using power from the battery 5 when vapor is required, for example in response to a signal from an air pressure sensor or air flow sensor (not shown) that detects an inhalation on the system 10 during which air enters through one or more air inlets 26 in the wall of the control unit 20. As will be described in more detail, the present disclosure envisages the use of the aerosol generator as the sensor for detecting air flow through the device.

When the heating element 4 is operated, the heating element 4 vaporizes aerosol generating material delivered from the reservoir 3 by the liquid delivery element 6 to generate the aerosol, and this is then inhaled by a user through the opening in the mouthpiece 35. The aerosol is carried from the aerosol generating material to the mouthpiece 35 along one or more air channels (not shown) that connect the air inlet 26 to the aerosol source to the air outlet when a user inhales on the mouthpiece 35.

The control unit (power section) 20 and the cartomizer (cartridge assembly) 30 are separate connectable parts detachable from one another by separation in a direction parallel to the longitudinal axis, as indicated by the double-ended arrows in FIG. 1. The components 20, 30 are joined together when the device 10 is in use by cooperating engagement elements 21, 31 (for example, a screw or bayonet fitting) which provide mechanical and in some cases electrical connectivity between the power section 20 and the cartridge assembly 30. Electrical connectivity is required if the heater 4 operates by ohmic heating, so that current can be passed through the heater 4 when it is connected to the battery 5. In systems that use inductive heating, electrical connectivity can be omitted if no parts requiring electrical power are located in the cartomizer 30.

An inductive work coil can be housed in the power section 20 and supplied with power from the battery 5, and the cartomizer 30 and the power section 20 shaped so that when they are connected, there is an appropriate exposure of the heater 4 to flux generated by the coil for the purpose of generating current flow in the material of the heater. Inductive heating arrangements are discussed further below.

The FIG. 1 design is merely an example arrangement, and the various parts and features may be differently distributed between the power section 20 and the cartridge assembly section 30, and other components and elements may be included. The two sections may connect together end-to-end in a longitudinal configuration as in FIG. 1, or in a different configuration such as a parallel, side-by-side arrangement. The system may or may not be generally cylindrical and/or have a generally longitudinal shape. Either or both sections or components may be intended to be disposed of and replaced when exhausted (the reservoir is empty or the battery is flat, for example), or be intended for multiple uses enabled by actions such as refilling the reservoir and recharging the battery. In other examples, the system 10 may be unitary, in that the parts of the control unit 20 and the cartomizer 30 are comprised in a single housing and cannot be separated. Embodiments and examples of the present disclosure are applicable to any of these configurations and other configurations of which the skilled person will be aware.

According to a first aspect, there is provided a non-combustible aerosol delivery device comprising a controller and a power source, the controller configured to deliver power to an aerosol generator according to one or more power profiles selected from at least a sensing power profile and an aerosolization power profile, wherein a power according to the sensing power profile is insufficient to increase the temperature of the aerosol generator above about 100° C.

The sensing power profile is a power profile selected so as to enable detection of airflow through the device. In some examples, the power profile represents the minimum amount of power required to facilitate a detectable change in the temperature of the aerosol generator resulting from the commencement of airflow through the device. This ensures that the use of the aerosol generator as a flow sensor does not lead to unacceptable use of power. In some examples, the minimum amount of power to be supplied to the aerosol generator is determined based on the ambient temperature. Put another way, a power according to the sensing power profile is maintains the temperature of the aerosol generator at below about 100° C. until a puff is detected.

In particular, when the sensing power profile is applied to the aerosol generator, power is provided so as to facilitate determination of airflow through the device. In particular, as a result of supplying power to the aerosol generator, its temperature will increase. This increase in temperature can be measured. This measurement can be carried out using a specific temperature sensor, or by measuring one or more electrical characteristics of the aerosol generator, such as ohmic resistance. When air travels through the aerosol delivery device following inhalation on the device by a user during an inhalation event, the air will travel in proximity to the aerosol generator. This travelling air will displace the stationary air that was in proximity to the aerosol generator before the inhalation event began. Assuming the incoming air is at a lower temperature than the static air in proximity to the aerosol generator (which is likely to be the case since the static air will have been heated to some extent following the delivery of power to the aerosol generator), the incoming air will have a “cooling effect” on the aerosol generator. This “cooling effect” may mean that the temperature of the aerosol generator actually decreases. Alternatively, it may mean that the rate at which the temperature of the aerosol generator was increasing slows (or even stops). Thus, measuring the temperature of the aerosol generator can facilitate the detecting of airflow through the device. Thus, it can be understood that the aerosol generator is acting as a thermistor and is detecting the commencement of airflow through the device as a result of its temperature profile changing due to the air travelling through the system.

It will be understood that the sensing power profile can be a constant power or a variable power, provided that the power delivered is insufficient to raise the temperature of the aerosol generator above 100° C.

In some examples, a constant power is delivered to the aerosol generator during the sensing power profile. The constant power may be selected to maintain the aerosol generator at a target temperature. The effect resulting from external air being drawn through the device during an inhalation may mean that more power is required to be supplied to the aerosol generator by the controller so as to maintain that target temperature. It will therefore be understood that direct measurement of the temperature of the aerosol generator is not strictly required for determining airflow. Rather, it is possible to empirically determine for any given aerosol generator the amount of power that needs to be supplied to it in order to maintain a particular target temperature under particular conditions. On the assumption that those particular conditions are present, and also that the aerosol generator is formed from a material with a non-zero thermal coefficient of resistivity, deviation of the power from its initial value will serve as an indication that the temperature of the aerosol generator has changed. The controller can determine this change in power delivery and thus infer that air is flowing past the aerosol generator.

It is advantageous to use the aerosol generator as the sensor for detecting commencement of airflow through the device because this removes the need for one or more other sensors, buttons etc. to activate the device. Moreover, it is possible that other types of sensor, such as microphone pressure sensors, are susceptible to fouling given the environment within which they operate. However, the present inventors have found that utilizing the aerosol generator as the sensor for detecting commencement of airflow through the device can lead to other problems. For example, since the aerosol generator is generally in proximity to the aerosolizable material, providing power to the aerosol generator at times when an aerosol is not required can lead to unnecessary generation of aerosol. This could lead to a waste of aerosolizable material. Additionally, since it is not generally known when an inhalation might occur, power might have to be delivered to the aerosol generator almost constantly. This can lead to an unacceptable drainage of the power supply.

According to the present invention, configuring the controller to deliver power to the aerosol generator according to one or more power profiles selected from a sensing power profile and an aerosolization power profile, whilst ensuring that the sensing power profile delivers insufficient power to raise the temperature of the aerosol generator above about 100° C., can alleviate one or more of the above mentioned problems. For example, by ensuring that the temperature of the aerosol generator does not rise above about 100° C., it is possible to ensure that the extent of aerosolization of any aerosolizable material during sensing is limited. This is advantageous since power may be provided according to the sensing power profile for a relatively long time whilst waiting for the detection of an inhalation and thus it is important that significant aerosolization of the aerosolizable material is not promoted.

As explained above, the amount of power supplied to the aerosol generator according to the sensing power profile is at least the minimum required to facilitate a subsequent detectable change in the temperature of the aerosol generator resulting from the commencement of airflow through the device. This is advantageous in that a minimum amount of power from the power source is used and thus the user is not faced with a power source which is significantly depleted even before aerosol generation has commenced.

As will be appreciated, the extent to which power is supplied according to the sensing power profile can be determined based on the ambient temperature, since the ambient temperature will generally influence the temperature of the incoming air. In some embodiments, power delivered according to the sensing power profile is sufficient to raise the temperature of the aerosol generator to at least about 1° C. above ambient temperature. In some embodiments, power delivered according to the sensing power profile is sufficient to raise the temperature of the aerosol generator to at least about 5° C. above ambient temperature. In some embodiments, power delivered according to the sensing power profile is sufficient to raise the temperature of the aerosol generator to at least about 10° C. above ambient temperature. In some embodiments, power delivered according to the sensing power profile is sufficient to raise the temperature of the aerosol generator to at least about 15° C. above ambient temperature. In some embodiments, power delivered according to the sensing power profile is sufficient to raise the temperature of the aerosol generator to at least about 20° C. above ambient temperature. In some embodiments, power delivered according to the sensing power profile is sufficient to raise the temperature of the aerosol generator to at least about 25° C. above ambient temperature. In some embodiments power delivered according to the sensing power profile is sufficient to raise the temperature of the aerosol generator to at least about 30° C. above ambient temperature.

In some embodiments, the power delivered according to the sensing power profile is insufficient to raise the temperature of the aerosol generator to above about 100° C. In some embodiments, power delivered according to the sensing power profile is insufficient to raise the temperature of the aerosol generator to above about 95° C. In some embodiments, power delivered according to the sensing power profile is insufficient to raise the temperature of the aerosol generator to above about 90° C. In some embodiments, power delivered according to the sensing power profile is insufficient to raise the temperature of the aerosol generator to above about 85° C.

In some embodiments, power delivered according to the sensing power profile is insufficient to raise the temperature of the aerosol generator to above about 80° C. In some embodiments, power delivered according to the sensing power profile is insufficient to raise the temperature of the aerosol generator to above about 75° C. In some embodiments, power delivered according to the sensing power profile is insufficient to raise the temperature of the aerosol generator to above about 70° C. In some power delivered according to the sensing power profile is insufficient to raise the temperature of the aerosol generator to above about 65° C. In some embodiments, power delivered according to the sensing power profile is insufficient to raise the temperature of the aerosol generator to above about 60° C. In some embodiments, power delivered according to the sensing power profile is insufficient to raise the temperature of the aerosol generator to above about 55° C. In some embodiments, power delivered according to the sensing power profile is insufficient to raise the temperature of the aerosol generator to above about 50° C. In some embodiments, power delivered according to the sensing power profile is insufficient to raise the temperature of the aerosol generator to above about 45° C. In some embodiments, power delivered according to the sensing power profile is insufficient to raise the temperature of the aerosol generator to above about 40° C.

In some embodiments, power delivered according to the sensing power profile is insufficient to raise the temperature of the aerosol generator to above about 35° C.

In some embodiments, power delivered according to the sensing power profile maintains the aerosol generator at a target temperature. The target temperature can be within the range of from about 1° C. above ambient temperature to about 100° C.

It will be appreciated that the precise power of the sensing power profile may vary depending on the specific configuration of the aerosol generator. The skilled person is able to empirically determine the appropriate power setting whilst taking account of the principle of providing enough power to ensure the minimum required temperature rise to facilitate a subsequent detectable change in the temperature of the aerosol generator resulting from the commencement of airflow through the device, whilst minimizing or avoiding the aerosolization of any aerosolizable material.

As explained above, it may also be that the power setting of the sensing power profile is dependent on the ambient temperature. In the context of the present disclosure, ambient temperature is to be understood as meaning the temperature in the local environment of the aerosol delivery device in the period immediately prior to an inhalation event. In some embodiments, the aerosol delivery device includes a sensor which is able to measure the ambient temperature. Alternatively, the controller of the aerosol delivery device may be configured to receive information relating to the ambient temperature from an external device. In some embodiments, the ambient temperature is determined to be the temperature of the local environment in the period of 5s or less before an inhalation takes place. In some embodiments, the ambient temperature is determined to be the temperature of the local environment in the period of 4s or less before an inhalation takes place. In some embodiments, the ambient temperature is determined to be the temperature of the local environment in the period of 3s or less before an inhalation takes place. In some embodiments, the ambient temperature is determined to be the temperature of the local environment in the period of 2s or less before an inhalation takes place. In some embodiments, the ambient temperature is determined to be the temperature of the local environment in the period of 1s or less before an inhalation takes place. By limiting the period of time for which a local temperature is considered to be ambient, it is possible to mitigate any adverse impact of the device being stored in an artificially high or low temperature environment, e.g. in the pocket of a user.

In some embodiments, the power setting of the sensing power profile is variable. In other words, the power delivered from the power source during the sensing power profile is not fixed. This may be because an initial relatively large amount of power might be needed to transition the aerosol generator from being in the ambient state to being in the “sensing” state. Once the “sensing” state is attained, however, the ongoing amount of power required to maintain that state may be relatively small. In this way the power setting of the sensing power profile may vary. Of course, as explained elsewhere, the power setting of the sensing power profile may vary based on other factors.

For example, where the ambient temperature is determined to be relatively lower, the controller may provide relatively less power to the aerosol generator when delivering power according to the sensing power profile, since the lower ambient temperature will generally mean that the incoming air is of a lower temperature. The opposite situation may occur when the ambient temperature is relatively higher. Thus, in some embodiments the amount of power supplied to the aerosol generator according to the sensing power profile is based on the ambient temperature. In some embodiments, the amount of power supplied to the aerosol generator according to the sensing power profile is directly proportional to the ambient temperature.

It will be appreciated that during delivery of power according to the sensing power profile, the controller may be configured to detect commencement of airflow through the device based on a determined change in a relationship between the power delivered to the aerosol generator and temperature of the aerosol generator. In some examples, the change in relationship is an increase in power required to maintain the target temperature. In some examples, the change in relationship is a decrease in temperature based on delivery of a constant power to the aerosol generator. The magnitude of the temperature change is from about 5° C. to about 20° C., for example from about 10° C. to about 15° C.

Upon detection of airflow, the controller switches to deliver power to the aerosol generator according to an aerosolization power profile. According to the aerosolization power profile, power is supplied to the aerosol generator at a level sufficient to raise the temperature of the aerosol generator above about 100° C., for example above about 150° C., above about 200° C., or above about 250° C.

In some embodiments, the controller is configured to deliver power according to the sensing power profile only in times when an inhalation may be anticipated. For example, the device may comprise one or means for estimating when an inhalation may be about to occur. For example, the device could comprise an accelerometer, which could determine that the device is being moved towards the mouth of a user. Other means of estimating when an inhalation may be about to occur can be based on the controller logging patterns of usage and using such patterns to predict future patterns of use.

In some embodiments, the controller is configured to deliver power according to the sensing power profile during parts of an inhalation, i.e. even after airflow has been detected. For example, the controller can be configured to monitor the airflow rate through the device. This could be done, for example, based on a change in a relationship between the power delivered to the aerosol generator and temperature of the aerosol generator. More specifically, where the aerosolization power profile is a constant power, a specific drop in the temperature of the aerosol generator (determined via one or more electrical characteristics of the aerosol generator as explained above) may be correlated to a particular flow rate. Conversely, the controller may be configured such that power delivered according to the aerosolization power profile is varied so as to maintain the aerosol generator at a target temperature. A specific increase in power delivery (as measured by the controller) may be correlated to a particular flow rate. For example, if relatively more power is being supplied for a particular temperature of the aerosol generator, this can be inferred as a higher flow rate.

The airflow rate could of course be determined with an additional sensor, such as a dedicated flow rate sensor.

The controller may be configured to monitor the flow rate during an inhalation period and to modulate the power to the aerosol generator based on the flow rate. In some embodiments, the controller may be configured to determine whether the airflow rate during an inhalation event is increasing, decreasing or has dropped below a defined threshold. In some embodiments, the controller may be configured to determine the peak airflow rate during an inhalation event.

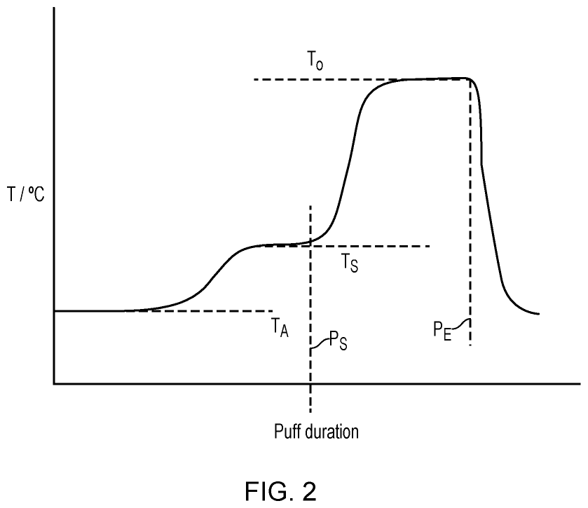

FIG. 2 shows an exemplary indication of how power profiles may be selected and applied by the controller during an inhalation event. In particular, FIG. 2 shows a graph of aerosol generator temperature corresponding to puff duration. P_{S} corresponds to the start of a puff as detected by the controller. Prior to P_{S} being detected, the temperature of the aerosol generator is as T_{S}, which refers to the temperature when receiving power according to the sensing power profile. The temperature T_{S} is higher than T_{A} since the power delivered to the aerosol generator in accordance with the sensing power profile has resulted in an increase in temperature. The value of T_{S} according to FIG. 2 is above ambient, but below 100° C.

Upon detection of P_{S} (as explained above, by monitoring for a change in a relationship between the power delivered to the aerosol generator and temperature of the aerosol generator, the controller switches to apply power to the aerosol generator in accordance with the aerosolization power profile such that To is reached (corresponding to the operational temperature at which stable aerosolization occurs). To is maintained until the controller determines that the airflow rate has peaked, at which point power is reduced or withdrawn from the aerosol generator. Power may still be delivered according to the aerosolization power profile if the controller is configured to ensure the temperature of the aerosol generator remains above 100° C. Alternatively, upon detection that airflow rate is decreasing, the controller may switch power delivery to the sensing power profile. This switch may be done immediately, or only when the temperature of the aerosol generator has been detected as decreasing to below 100° C., or to the selected T_{S}. Alternatively, power may be withdrawn altogether if it is anticipated that another inhalation is not expected. Thus, the temperature of the aerosol generator may return to ambient T_{A}. As explained above, the controller may be configured to apply the sensing power profile shortly in advance of when the next puff is anticipated.

When the controller infers that the user is stopping inhaling, P_{E} (puff end) for example due to detection of a decreasing airflow signifying the end of a puff, the controller may be configured to monitor the rate of temperature decrease of the aerosol generator. Since this may require the provision of power to the aerosol generator (where an electrical characteristic of the aerosol generator, such as resistance is being used to determine its temperature), during periods of decreasing airflow the controller may be configured to “ping” the aerosol generator with low amounts of power just sufficient to derive an electrical characteristic of the aerosol generator. When the temperature of the aerosol generator is determined to have dropped below a threshold value, e.g. 100° C., the controller can revert to providing power to the aerosol generator in accordance with the sensing power profile described above. In some embodiments, this threshold value is 95° C. In some embodiments, this threshold value is 90° C. In some embodiments, this threshold value is 85° C. In some embodiments, this threshold value is 80° C. In some embodiments, this threshold value is 75° C. In some embodiments, this threshold value is 70° C. In some embodiments, this threshold value is 65° C. In some embodiments, this threshold value is 60° C. In some embodiments, this threshold value is 55° C. In some embodiments, this threshold value is 50° C. In some embodiments, this threshold value is 45° C. In some embodiments, this threshold value is 40° C.

The rate of temperature decay from T_{O} can also be used to infer the presence of aerosolizable material since this will have an impact on the rate of temperature decrease. Where the rate of temperature decrease is relatively fast, this may indicate a relatively sufficient supply of aerosolizable material in proximity to the aerosol generator (since the material will act as a heat sink for latent heat within the aerosol generator). On the other hand, where the rate of temperature decrease is relatively slow, this may indicate a relatively insufficient supply of aerosolizable material (since less material is available to act as a heat sink for latent heat within the aerosol generator). Accordingly, during the rate of temperature decay during the end of a puff may be used to infer the presence or absence of liquid in the system. The rate of temperature decay may be dependent not only on the amount of aerosolizable material in proximity to the aerosol generator, but also on any residual airflow through the device (noting that airflow does not immediately drop to zero when a user begins the process of ending a puff; rather, the puff profile may approximate a bell curve with the end of the puff occurring at the apex of the curve). Thus, the controller may be configured to take into account any contribution from this residual airflow when inferring the presence or absence of liquid in the system. Further, the rate of temperature decay may be dependent not only on the amount of aerosolizable material in proximity to the aerosol generator and/or residual airflow, but also on the thermal conductivity of the aerosol generator. For any given system, the skilled person can empirically determine the impact of residual airflow and the thermal conductivity of the aerosol generator on the rate of temperature decay from T_{O} and thus can use the rate of decay as an indication of amount of aerosolizable material remaining.

Accordingly, there is also disclosed herein a method of determining an amount of aerosolizable material remaining in non-combustible aerosol delivery system comprising an aerosol generator, the method comprising determining the rate of temperature decay of the aerosol generator following the cessation of airflow through the device. In some examples, the method further includes determining the amount of aerosolizable material remaining in non-combustible aerosol delivery system based on the residual airflow rate through the device. The method may also comprise accounting for the thermal conductivity of the aerosol generator.

In a further aspect, there is provided a method of sensing the commencement of airflow through an aerosol delivery device, the method comprising the steps of:
providing an aerosol delivery device comprising a controller and a power source, wherein the controller is configured to deliver power according to an aerosol generator according to one or more power profiles selected from at least a sensing power profile and an aerosolization power profile, wherein the sensing power profile is insufficient to increase the temperature of the aerosol generator above about 100° C.,
delivering power to an aerosol generator according to the sensing power profile;
determining whilst delivering power according to the sensing power profile a change in a relationship between the power delivered to the aerosol generator and temperature of the aerosol generator.

The disclosures made above relating to the system/device apply equally to the aspect of the above mentioned method. They are not repeated here in the interests of brevity, but this should not be construed as implying that such described features can not apply equally to the method.

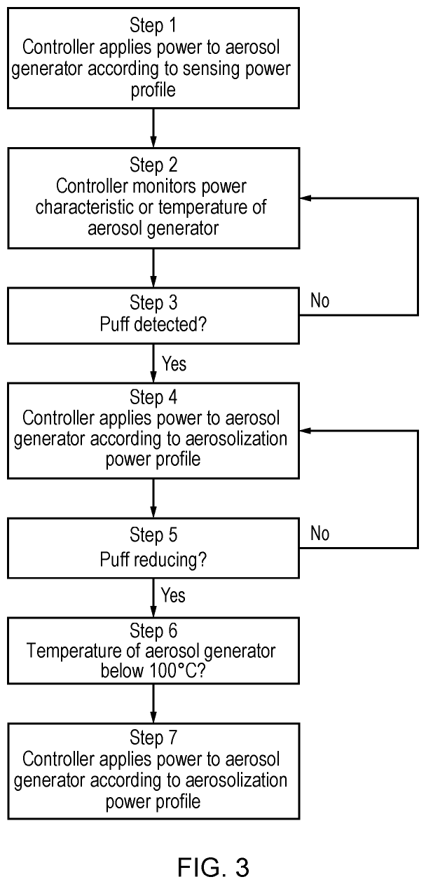

FIG. 3 is a flow chart illustrating how the method of described above can be implemented by a controller as described herein.

In conclusion, in order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc. other than those specifically described herein. The disclosure may include other inventions not presently claimed, but which may be claimed in future.

1. A non-combustible aerosol delivery device comprising a controller and a power source, the controller configured to deliver power to an aerosol generator according to one or more power profiles selected from at least a sensing power profile and an aerosolization power profile, wherein a power according to the sensing power profile is insufficient to increase the temperature of the aerosol generator above about 100° C.

2. The aerosol delivery device according to claim 1, wherein during delivery of power according to the sensing power profile the controller is configured to detect commencement of airflow through the device based on a determined change in a relationship between the power delivered to the aerosol generator and temperature of the aerosol generator.

3. The aerosol delivery device according to claim 1, wherein a constant power is delivered to the aerosol generator during the sensing power profile.

4. The aerosol delivery device according to claim 3, wherein the constant power is selected to maintain the aerosol generator at a target temperature.

5. The aerosol delivery device according to claim 4, wherein the target temperature of is at least about 5° C. above ambient temperature.

6. The aerosol delivery device according to claim 4, wherein the target temperature is from about 20° C. to about 100° C.

7. The aerosol delivery device according to claim 4, wherein the change in relationship is an increase in power required to maintain the target temperature.

8. The aerosol delivery device according to claim 1, wherein the change in relationship is a decrease in temperature based on delivery of a constant power to the aerosol generator.

9. The aerosol delivery device according to claim 8, wherein the magnitude of the temperature change is from about 5° C. to about 20° C.

10. The aerosol delivery device according to claim 1, wherein following the determination of commencement of airflow through the device, the controller is configured to switch to operate according to the aerosolization power profile whereby the power delivered to the aerosol generator is greater than for the sensing power profile.

11. The aerosol delivery device according to claim 10, wherein during the aerosolization power profile sufficient power is delivered to the aerosol generator to raise the temperature of the aerosol generator above about 100° C.

12. The aerosol delivery device according to claim 1, wherein the controller is configured to determine the air flow rate through the device.

13. The aerosol delivery device according to claim 12, wherein the air flow rate is determined based on a change in a relationship between the power delivered to the aerosol generator and temperature of the aerosol generator.

14. The aerosol delivery device according to claim 12, further comprising a flow sensor to determine the air flow rate.

15. The aerosol delivery device according to claim 12, wherein upon determination that the air flow rate through the device has decreased from a peak airflow rate the controller is configured to reduce the power delivered to the aerosol generator.

16. The aerosol delivery device according to claim 15, wherein the controller is configured to reduce the power delivered to the aerosol generator to the sensing power profile.

17. The aerosol delivery device according to claim 1, wherein the temperature of the aerosol generator is monitored by the controller.

18. The aerosol delivery device according to claim 17, wherein the temperature of the aerosol generator is monitored using one or more electrical characteristics.

19. The aerosol delivery device according to claim 18, wherein the temperature of the aerosol generator is determined based on the electrical resistance of the aerosol generator.

20. The aerosol delivery device according to claim 17, further comprising a temperature sensor to monitor the temperature of the aerosol generator.

21. The aerosol delivery device according to claim 17, wherein the temperature of the aerosol generator is monitored by the controller when delivering power according to the sensing power profile.

22. The aerosol delivery device according to claim 1, wherein the aerosol generator is capable of being heated via induction.

23. The aerosol delivery device according to claim 1, wherein the device comprises a control housing comprising the power source and the controller, and an aerosol generator connected to the control housing.

24. The aerosol delivery device according to claim 23, wherein the aerosol generator forms part of an article that is separable from the control housing.

25. The aerosol delivery device according to claim 1, wherein the article further comprises a store for receiving aerosolizable material.

26. A method of sensing the commencement of airflow through an aerosol delivery device, the method comprising the steps of:
providing an aerosol delivery device comprising a controller and a power source, wherein the controller is configured to deliver power according to an aerosol generator according to one or more power profiles selected from at least a sensing power profile and an aerosolization power profile, wherein the sensing power profile is insufficient to increase the temperature of the aerosol generator above about 100° C.,
delivering power to an aerosol generator according to the sensing power profile; and
determining whilst delivering power according to the sensing power profile a change in a relationship between the power delivered to the aerosol generator and temperature of the aerosol generator.

27. (canceled)
